(19) United States
(12) Patent Application Publication
(10) Pub. No.: US 2025/0332637 A1
(43) Pub. Date: Oct. 30, 2025

(54) MOLD AND METHOD FOR FORMING SPECIAL-SHAPED MAGNETIC STEEL

(71) Applicant: AAC Kaitai Technologies (Ma'anshan) Co., Ltd., Ma'anshan, Anhui (CN)

(72) Inventors: Chenhao Li, Ma'anshan (CN); Jianneng Zhang, Ma'anshan (CN); Mingbo Wang, Ma'anshan (CN); Jie He, Ma'anshan (CN); Ben Li, Ma'anshan (CN)

(21) Appl. No.: 18/900,851

(22) Filed: Sep. 29, 2024

Related U.S. Application Data
(63) Continuation of application No. PCT/CN2024/089757, filed on Apr. 25, 2024.

(51) Int. Cl. B22F 3/00; B22F 3/16; H01F 41/02

(52) U.S. Cl. CPC B22F 3/003; B22F 3/004; B22F 3/16; H01F 41/0246; B22F 2202/05; B22F 2301/35; B22F 2304/10; B22F 2998/10; B22F 2999/00

(57) ABSTRACT

A mold and a method for forming special-shaped magnetic steel. The mold includes a powder filling device including mold cavities, each including an opening at one end and having a first preset shape; a powder distribution device including a powder distribution area in which powder distribution channels are provided and penetrates through the powder distribution device along a first direction parallel to a height direction of the powder distribution device, and each has a second preset shape same ass the first preset shape, positions of the powder distribution channels corresponding to positions of the mold cavities; and a cover plate configured to close the mold cavities. The formed workblank is subjected to reinforced molding in the orientation treatment process, the molding density and the orientation degree of the magnetic steel is improved, and a special-shaped magnetic steel product with high remanence and high coercivity is obtained.

### TECHNICAL FIELD

The present disclosure relates to the technical field of permanent magnets, in particular to a mold and a method for forming special-shaped magnetic steel.

### BACKGROUND

With the development of new permanent magnet materials, microelectronics technology, automatic control technology and power electronics technology, motors have been widely developed. The motor uses electronic reversing to replace conventional mechanical reversing, and has gradually developed from the original military field to various fields such as aerospace, medical treatment, household appliances and industrial automation by virtue of the advantages of reliable performance, no abrasion, low failure rate, small volume, high efficiency and the like.

For a permanent magnet motor, an air gap magnetic field is generated by means of a permanent magnet (namely, magnetic steel) to be functional, without needing to apply extra electric energy or provide extra windings. In a forming process of magnetic steel in the related art, a shape of the magnetic steel not only involves a regular cuboid shape, but also involves irregular shapes such as a bread-type shape and a tile-type shape (that is, special-shaped magnetic steel), therefore, a cutting process is necessary in the forming process of magnetic steel. In this case, a part of raw material is wasted, an utilization rate of the magnetic steel is low, and the process efficiency is low; in addition, in the forming process of the magnetic steel, the magnetic steel is inevitably oxidized, and a part that is oxidized and deformed needs to be removed by a cutting process, resulting in a low utilization rate of the magnetic steel.

In recent years, a designed mold is often used for forming special-shaped magnetic steel. Generally, firstly, a workblank dimension is determined according to an order dimension and machining allowance; then, a pressing direction size is calculated according to a fixed shrinkage ratio and a mold is designed; then, powder is loaded into a mold cavity, and a workblank is formed after pressing, isostatic pressing and firing. Due to the fact that for the magnetic steel, the granularity is relatively fine, the viscosity is large, and the fluidity is poor, after the powder is put into the special-shaped mold cavity, the powder is prone to overhead at a special-shaped position having a small space, as a result, the density of the filled part of the formed compact powder is high, and the density of the overhead part of the powder is low, leading to that the overall density and the orientation degree of the magnetic steel are poor.

### SUMMARY

The existing mold for forming special-shaped magnetic steel must adopt an isostatic pressing treatment, as a result, the remanence and coercivity of the special-shaped magnetic steel formed by the mold are poor.

In view of this, the present disclosure provides a mold and a method for forming special-shaped magnetic steel. The special-shaped magnetic steel formed by the mold of the present disclosure can achieve forming and sintering of fine-grained powder without an isostatic pressing treatment, thus, a magnetic steel product with high remanence and high coercivity can be obtained. Meanwhile, direct forming and sintering of the product size and shape can be achieved, the forming procedure of the workblank can simplified, the material utilization rate can be improved, and the production efficiency can be improved.

In an embodiment, an embodiment of the present disclosure provides a mold for forming special-shaped magnetic steel. The mold includes: a powder filling device, the powder filling device including a plurality of mold cavities, each of the plurality of mold cavities including an opening at one end, and each of the plurality of mold cavities having a first preset shape; a powder distribution device, the powder distribution device including a powder distribution area, and a plurality of powder distribution channels being provided in the powder distribution area, the plurality of powder distribution channels penetrating through the powder distribution device along a first direction, each of the plurality of powder distribution channels having a second preset shape, positions of the plurality of powder distribution channels corresponding to positions of the plurality of mold cavities, the first preset shape being the same as the second preset shape, and the first direction being parallel to a height direction of the powder distribution device; and a cover plate configured to close the plurality of mold cavities.

As an improvement, the powder filling device includes a bottom plate and a powder filling plate arranged on the bottom plate, the powder filling plate includes a plurality of powder filling channels penetrating through the powder filling plate along the first direction, positions of the plurality of powder filling channels correspond to the positions of the plurality of powder distribution channel, and the plurality of powder filling channels and the bottom plate jointly enclose to define the plurality of mold cavities.

As an improvement, the powder distribution device includes a support plate and a powder distribution plate arranged at a side of the support plate, the plurality of powder distribution channels are arranged at the powder distribution plate, the support plate includes a first hollow area, and the first hollow area corresponds to the plurality of powder distribution channels.

As an improvement, a length of the support plate along a second direction is greater than a length of the powder distribution plate along the second direction, and the second direction is perpendicular to the first direction.

As an improvement, the powder distribution device further includes a reinforcing plate arranged at a side of the support plate, the reinforcing plate and the powder distribution plate are respectively arranged at two sides of the support plate, the reinforcing plate is arranged at a side of the support plate facing away from the powder filling device, the reinforcing plate includes a second hollow area, and the second hollow area corresponds to the first hollow area; and a length of the reinforcing plate along the first direction is greater than a length of the support plate along the first direction, and the length of the reinforcing plate along the first direction is greater than a length of the powder distribution plate along the first direction.

As an improvement, the mold further includes a fixing device, the fixing device is configured to lock the cover plate and the powder distribution device along the first direction and along a second direction perpendicular to the first direction.

As an improvement, the powder filling device is detachably connected to the powder distribution device, and/or the powder distribution device is detachably connected to the cover plate.

As an improvement, the first preset shape includes at least one of a bread-type shape, a tile-type shape and a tile-like shape.

In another aspect, an embodiment of the present disclosure provides a method for forming special-shaped magnetic steel, the special-shaped magnetic steel is formed by a mold. The mold includes: a powder filling device, the powder filling device including a plurality of mold cavities, each of the plurality of mold cavities including an opening at one end, and each of the plurality of mold cavities having a first preset shape; a powder distribution device, the powder distribution device including a powder distribution area, and a plurality of powder distribution channels being provided in the powder distribution area, the plurality of powder distribution channels penetrating through the powder distribution device along a first direction, each of the plurality of powder distribution channels having a second preset shape, positions of the plurality of powder distribution channels corresponding to positions of the plurality of mold cavities, the first preset shape being the same as the second preset shape, and the first direction being parallel to a height direction of the powder distribution device; and a cover plate configured to close the plurality of mold cavities. The method includes: providing the mold; stacking the powder distribution device and the powder filling device, in such a manner that the plurality of mold cavities are in one-to-one correspondence with the plurality of powder distribution channels; filling a magnetic raw material into the plurality of mold cavities through the plurality of powder distribution channels for a near-pressureless molding process, in such a manner that the magnetic raw material forms a plurality of workblanks in the plurality of mold cavities; each of the workblanks having the first preset shape; removing the powder distribution device, and closing the mold cavity by the cover plate; performing a magnetic orientation treatment on the magnetic raw material in the plurality of mold cavities to obtain a plurality of magnetic steel intermediates; and performing a heat treatment on each of the plurality of magnetic steel intermediates, to form a permanent magnet piece to obtain the special-shaped magnetic steel. The near-pressureless molding process, the magnetic orientation treatment and the heat treatment are performed in a low-oxygen atmosphere, in which an oxygen content is less than or equal to 10 ppm.

As an improvement, before performing the magnetic orientation treatment on the magnetic raw material in the plurality of mold cavities, the method further includes: locking the cover plate and the powder filling device in the first direction and in the second direction by using the fixing device.

As an improvement, the near-pressureless molding process includes at least one of a gas impact treatment, a vibration treatment or a permanent magnet raw material surface compaction treatment; the magnetic raw material has a median particle size ranging from 1 μm to 4 μm; the magnetic raw material that enters the plurality of mold cavities through the plurality of powder distribution channels has a density ranging from 2.7 g/cm³ to 4.0 g/cm³, and a density distribution of the magnetic raw material in the plurality of mold cavities of the powder filling device is less than or equal to 3%; an orientation degree of the workblank is greater than or equal to 97%; and magnetic induction intensity of the magnetic orientation treatment ranges from 2T to 7T, and the magnetic orientation treatment includes a pulse orientation treatment.

### BRIEF DESCRIPTION OF DRAWINGS

In order to better illustrate technical solutions in embodiments of the present disclosure or in the related art, the accompanying drawings used in the embodiments and in the related art are briefly introduced as follows. It should be noted that the drawings described as follows are merely part of the embodiments of the present disclosure, and other drawings can also be acquired by those skilled in the art without paying creative efforts.

FIG. 1 is a structural schematic diagram of a powder filling device according to an embodiment of the present disclosure;

FIG. 2 is a first structural schematic diagram of a powder distribution device according to the present disclosure;

FIG. 3 is a second structural schematic diagram of a powder distribution device according to the present disclosure;

FIG. 4 is a structural schematic diagram of a cover plate according to an embodiment of the present disclosure;

FIG. 5 is a structural schematic diagram of a powder filling device and a powder distribution device used cooperatively according to an embodiment of the present disclosure;

FIG. 6 is a structural schematic diagram of a powder filling device and a cover plate used cooperatively according to an embodiment of the present disclosure;

FIG. 7 is a structural schematic diagram of a powder filling plate according to an embodiment of the present disclosure;

FIG. 8 is a structural schematic diagram of a bottom plate according to an embodiment of the present disclosure;

FIG. 9 is a structural schematic diagram of a support plate according to an embodiment of the present disclosure;

FIG. 10 is a structural schematic diagram of a powder distribution plate according to an embodiment of the present disclosure;

FIG. 11 is a structural schematic diagram of a reinforcing plate according to an embodiment of the present disclosure;

FIG. 12 is a structural schematic diagram of a fixing device that fixes a powder filling device and a cover plate according to an embodiment of the present disclosure;

FIG. 13 is a structural schematic diagram of a first preset shape according to an embodiment of the present disclosure; and

FIG. 14 is a flowchart of a method for forming magnetic steel according to an embodiment of the present disclosure.

In the figures:

1—powder filling device; 101—mold cavity;

11—powder filling plate;

111—powder filling channel;

12—bottom plate;

2—powder distribution device; 2a—powder distribution area;

21—support plate;

21a—first hollow area;

22—powder distribution plate;

221—powder distribution channel;

23—reinforcing plate;

23a—second hollow area;

3—cover plate;

4—fixing device;

41—first fixing plate;

42—second fixing plate;

43—locking member.

### DESCRIPTION OF EMBODIMENTS

For better illustrating technical solutions of the present disclosure, embodiments of the present disclosure will be described in detail as follows with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

Magnetic steel is a magnetic material formed by a metal alloy such as iron, nickel and cobalt. It has strong magnetic capability and may play an important role in various applications. Magnetic steel has many unique properties, such as strong magnetism, high magnetic permeability, magnetic saturation and magnetic induction intensity. Magnetic steel is widely used in the fields of motors, electronic devices, magnetic materials and the like.

There are usually following two methods for forming magnetic steel in the related art: 1) a permanent magnet workblank is used as a raw material, the workblank is subjected to cutting, grinding and electric spark machining to form a workblank having a preset shape, and then post machining is performed to obtain the magnetic steel; 2) permanent magnet powder is placed in a magnetic field for orientation forming, then isostatic pressing treatment is performed to obtain a workblank, and then the workblank is sintered to obtain the magnetic steel.

In the above-mentioned two methods, in the method 1), the workblank waste is serious in the processing process, resulting in serious material waste; moreover, the working efficiency of the electric spark cutting process is low, and multiple pieces of equipment need to be laid, resulting in high cos; and in the method 2), the isostatic pressing treatment makes the product to be at a risk of being exposed to air, and remanence and coercivity of the magnetic steel are reduced.

In view of this, the embodiments of the present disclosure provide a mold, magnetic steel, and a method for forming the same, without using an isostatic pressing treatment or a molding pressing process. A magnetic raw material is preprocessed by using a near-pressureless molding process and the mold, and low-oxygen atmosphere is provided in the entire forming process, so that a magnetic steel product with high remanence and coercivity can be formed.

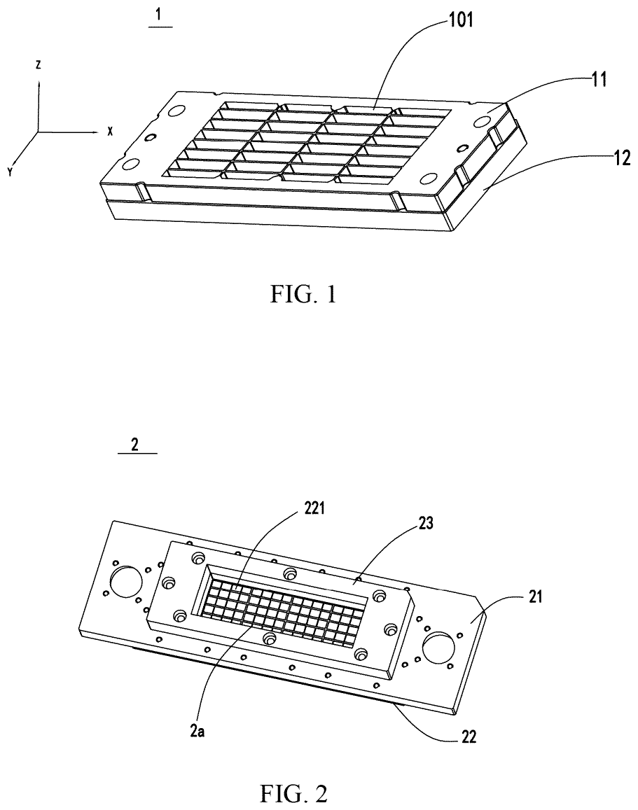

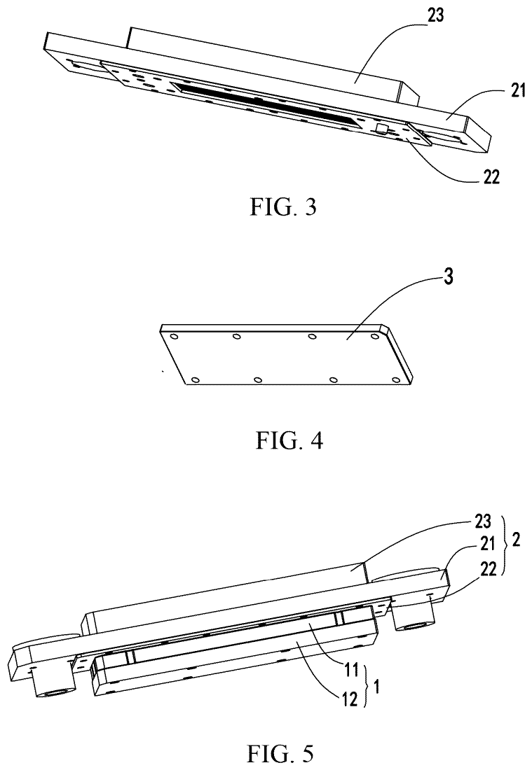

An embodiment of the present disclosure provides a mold for forming special-shaped magnetic steel. The mold includes a powder filling device 1, a powder distribution device 2 and a cover plate 3. FIG. 1 is a structural schematic diagram of a powder filling device according to an embodiment of the present disclosure, FIG. 2 is a structural schematic diagram 1 of a powder distribution device according to the present disclosure, FIG. 3 is a structural schematic diagram 2 of a powder distribution device according to the present disclosure, and FIG. 4 is a structural schematic diagram of a cover plate 3 according to an embodiment of the present disclosure. The powder filling device 1 is configured to be loaded with a magnetic raw material, the powder distribution device 2 is configured to distribute the magnetic raw material into the powder filling device 1, and the cover plate 3 is configured to close the powder filling device 1 that is loaded with the magnetic raw material.

Referring to FIG. 1, the powder filling device 1 includes a plurality of mold cavities 101, each of which has an opening at one end. The mold cavity 101 is used for be loaded with the magnetic raw material, the mold cavity 101 has a first preset shape, and the first preset shape is a shape of the finally formed special-shaped magnetic steel.

Referring to FIG. 2 and FIG. 3, the powder distribution device 2 includes a powder distribution area 2a, in which a plurality of powder distribution channels 221 are arranged. The powder distribution channel 221 penetrates through the powder distribution device 2 along a first direction, and the powder distribution channel 221 has a second preset shape. Positions of the plurality of powder distribution channels 221 correspond to positions of the plurality of mold cavities 101, and the first preset shape is the same as the second preset shape. The first direction is parallel to a height direction of the powder distribution device 2. FIG. 5 is a structural schematic diagram of a powder filling device and a powder distribution device cooperatively used according to an embodiment of the present disclosure, referring to FIG. 5, during the use of the mold, the powder distribution device 2 and the powder filling device 1 are cooperatively used to fill magnetic raw material into the powder filling device 1 through the powder distribution channel 221. Each mold cavity 101 corresponds to a respective powder distribution channel 221, and a same amount of magnetic raw material can be provided in each powder distribution channel 221 in a uniform weighing manner, so that uniform powder filling is realized.

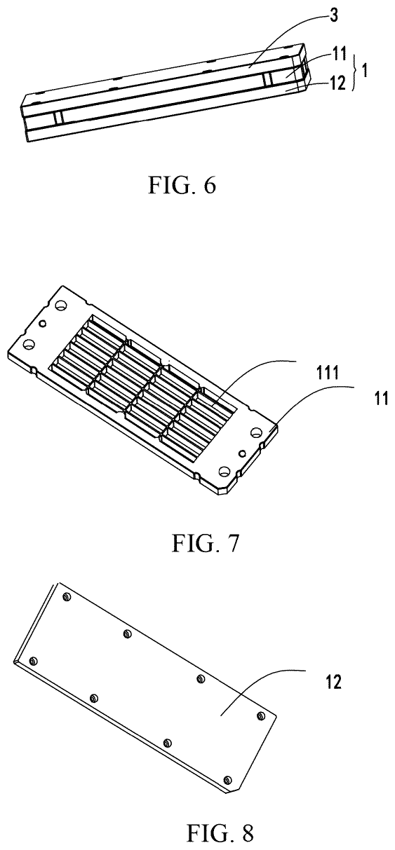

After the powder filling operation is completed, FIG. 6 is a structural schematic diagram of a powder filling device and a cover plate cooperatively used according to an embodiment of the present disclosure, referring to FIG. 3 and FIG. 6, the powder filling device 1 and the cover plate 3 are cooperatively used in such a manner that the cover plate closes the mold cavity 101 of the powder filling device 1.

According to the mold of the present disclosure, the powder filling device 1 and the powder distribution device 2 are cooperatively used in such a manner that the powder distribution channels 221 are in one-to-one correspondence with the mold cavities 101, so that the magnetic raw material can be uniformly distributed in the mold cavities of the powder filling device 1 by a near-pressureless molding process, without needing to use a conventional isostatic pressing process for pressing. Moreover, the first preset shape of the mold cavity 101 is the shape of the magnetic steel product, without needing to perform a cutting process, thereby effectively improving the utilization rate of the magnetic raw material. After the powder filling is completed, the mold cavity 101 is closed by the cover plate 3, so that the magnetic raw material in the mold cavity 101 is not exposed to the air. Thus, the magnetic raw material having a small particle size can be performed with a magnetic orientation treatment under an action of a large orientation field, so as to form the special-shaped magnetic steel with high remanence and high coercivity.

In the present disclosure, the first direction refers to the height direction of the powder distribution device 2, that is, the first direction is a Z-axis direction shown in FIG. 1, the second direction refers to a direction perpendicular to the first direction, and the second direction may be an X-axis direction shown in FIG. 1, or may be a Y-axis direction shown in FIG. 1. In the following description, the first direction being the Z-axis direction and the second direction being the X-axis direction are taken as an example for description.

In an example, a powder filling device 1 is used as a bearing platform of a mold cavity 101, the powder filling device 1 includes a bottom plate 12 and a powder filling plate 11 arranged on the bottom plate 12. FIG. 7 is a structural schematic diagram of the powder filling plate 11, and FIG. 8 is a structural schematic diagram of the bottom plate. Referring to FIG. 7 and FIG. 8, the powder filling plate 11 includes a powder filling channel 111, and the powder filling channel 111 has a first preset shape. The powder filling channel 111 penetrates through the powder filling plate 11 along a first direction, and the bottom plate 12 and the powder filling channel 111 jointly define the mold cavity 101. In this way, the mold cavity 101 can be formed by the bottom plate 12 and the powder filling plate 11, and is then loaded with a magnetic raw material. After the magnetic steel is formed by the magnetic raw material, the powder filling plate 11 and the bottom plate 12 may be detached from each other to obtain the magnetic steel.

In an example, the bottom plate 12 and the powder filling plate 11 may be detachably connected to each other, for example, a bolt hole may be provided at an area of the powder filling plate 11 where the powder filling channel 111 is not provided, and another bolt hole may be provided at the bottom plate 12 at a corresponding position, then a bolt may be used for fixing the bottom plate 12 and the powder filling plate 11.

In an example, the shape of the powder distribution channel 221 may be the same as the shape of the powder filling channel 111, which is the shape of the special-shaped magnetic steel. When the powder filling device 1 and the powder distribution device 2 are stacked, the position of the powder distribution channel 221 corresponds to the position of the powder filling channel 111, thereby achieving the powder distribution accuracy of the powder distribution device 2.

In an example, the number of the powder distribution channels 221 is the same as the number of the powder filling channels 111, and the number of the powder distribution channels 221 is the number of the mold cavities 101. The number of the mold cavities 101 may be plural. The sizes of the powder distribution channel 221 and the powder filling channel 111 may be designed according to the mass and volume of the magnetic steel product, to improve the adaptability of the mold, so that the mold provided by the embodiments of the present disclosure can be applied to the forming of magnetic steel of different specifications. The number of the mold cavities 101 is generally within a range from 1 to 200, so that batch forming of the magnetic steel product may be effectively improved, and the manufacturing efficiency of the magnetic steel may be greatly improved.

In an example, the powder filling plate 11 has a plate-shaped structure with a specific thickness, and the thickness of the powder filling plate 11 corresponds to a thickness of the prepared special-shaped magnetic steel.

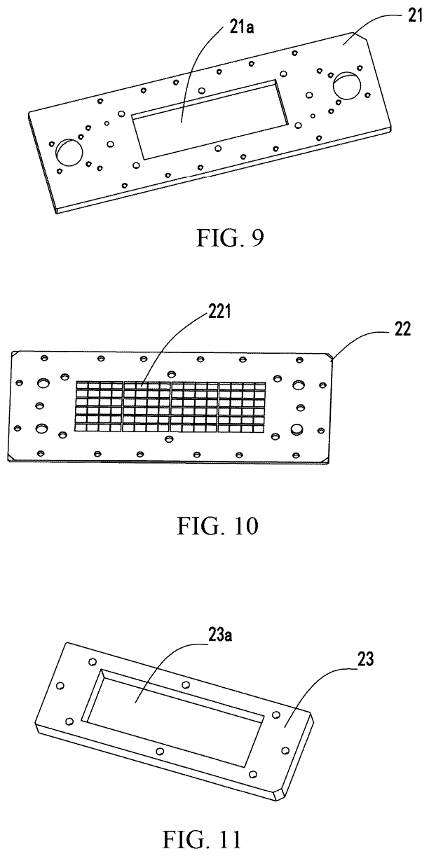

In an example, the powder distribution device 2 includes a support plate 21 and a powder distribution plate 22. FIG. 9 is a structural schematic diagram of the support plate, and FIG. 10 is a structural schematic diagram of the powder distribution plate. Referring to FIG. 3, FIG. 9 and FIG. 10, the support plate 21 and the powder distribution plate 22 are stacked, the support plate 21 includes a first hollow area 21a, the powder distribution channel 221 is provided at the powder distribution plate 22, the powder distribution channel 221 penetrates through the powder distribution plate 22, and the first hollow area 21a corresponds to the powder distribution channel 221. In the process of using the mold, the powder distribution device 2 and the powder filling device 1 are stacked, so that the powder distribution plate 22 and the powder filling plate 11 are in contact with each other to realize accurate powder distribution.

In an example, the shapes and sizes of the powder distribution plate 22 and the powder filling plate 11 are the same, so that the powder distribution channels 221 and the powder filling channels 111 are in one-to-one correspondence, thereby facilitating the accuracy of the powder distribution device 2 distributing powder into the mold cavities 101.

In an example, referring to FIG. 2, the length of the support plate 21 along the X-axis direction is greater than the length of the powder distribution plate 22 along the X-axis direction, that is, the length of the support plate 21 is greater than the length of the powder distribution plate 22. In the process for forming the special-shaped magnetic steel by the mold, this is convenient for operation of the powder distribution device 2, which is beneficial for the powder distribution device 2 to be placed on the powder filling device 1 and the powder distribution device 2 to be removed from the filling device. In addition, the support plate 21 may only satisfy that the length of the support plate 21 along the Y-axis direction is greater than the length of the powder distribution plate along the Y-axis direction, and the support plate 21 may also satisfy the following requirements: the length of the support plate 21 along the X-axis direction is greater than the length of the powder distribution plate 22 along the X-axis direction, and the length of the support plate 21 along the Y-axis direction is greater than the length of the powder distribution plate along the Y-axis direction, which will not be limited in the present disclosure, as long as the size of the support plate 21 is larger than the size of the powder distribution plate 22.

In an example, the powder distribution channel 221 is further provided with a reinforcing plate 23. FIG. 11 is a structural schematic diagram of the reinforcing plate. Referring to FIG. 3 and FIG. 11, the reinforcing plate 23 is arranged at a side of the support plate 21 away from the powder distribution plate 22, and the reinforcing plate 23 and the powder distribution plate 22 are respectively located at two sides of the support plate 21, so as to extend a path of powder distribution and improve uniformity of powder distribution. When the powder distribution device 2 and the powder filling device 1 are stacked, that is, the powder distribution device 2 is arranged on the upper portion of the powder filling device 1, and along a direction from the powder distribution device 22 towards the powder filling device 1, the powder distribution channel 221 corresponds to the mold cavity 101, so that the magnetic raw material can smoothly enter the powder distribution frame 21 through the powder distribution channel 221 and enter the mold cavity 101 through the second side of the powder distribution frame 21, thereby realizing the filling process of the magnetic raw material in the mold cavity 101. Since the shapes of the powder distribution channel 221 and the mold cavity 101 are the same, the accuracy of filling the mold cavity 101 with the magnetic raw material can be ensured, and the magnetic raw material passes through the powder distribution device 22 and then reaches the mold cavity 101, thereby prolonging a path for filling the magnetic raw material, improving the compactness of the magnetic raw material in the mold cavity 101, and thus being beneficial to improving the forming density of the magnetic steel.

In an example, the length of the reinforcing plate 23 along the Z-axis direction is greater than the length of the support plate 21 along the Z-axis direction, the length of the reinforcing plate 23 along the Z-axis direction is greater than the length of the powder distribution plate 22 along the Z-axis direction, and the length along the Z-axis direction is the thickness. That is, the thickness of the reinforcing plate 23 is greater than the thickness of the support plate 21 and the thickness of the powder distribution plate 22, thereby being beneficial to prolonging the path of the powder distribution and improving the uniformity of the powder distribution. Since the support plate 21 can achieve portable operation of the powder distribution device 2, the length and the width of the reinforcing plate 23 will not be limited in the present disclosure, and those skilled in the art can make a configuration/selection as needed.

In an example, for the powder distribution device 2, the supporting plate 21 and the powder distribution plate 22 may be detachably connected, and the supporting plate 21 and the reinforcing plate 23 may be detachably connected, so that a problem that the powder distribution accuracy is reduced due to deviation of a certain part in the use process of the powder distribution device 2 can be avoided. In an example, the support plate 21, the powder distribution plate 22 and the reinforcing plate 23 may be detachably connected.

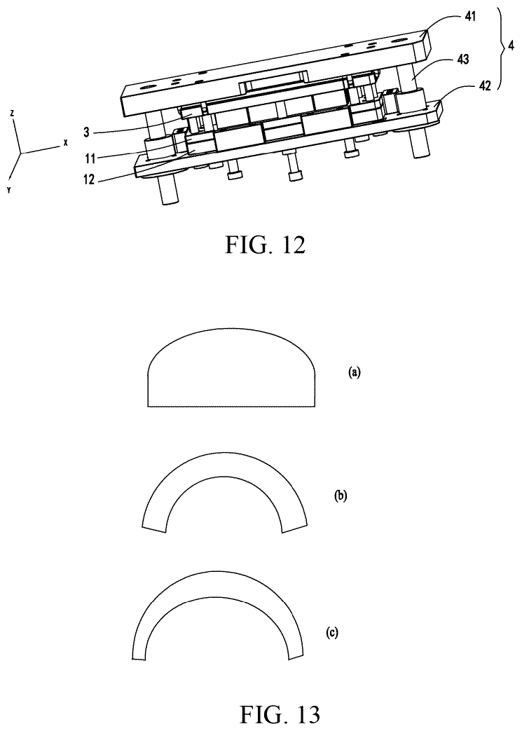

In an example, the mold further includes a fixing device 4. FIG. 12 is a structural schematic diagram of the fixing device 4 that fixes a powder filling device 1 and a cover plate 3. The fixing device includes a first fixing plate 41 disposed at a top of the cover plate 3, a second fixing plate 42 disposed at a bottom of the powder filling device, and a locking member 43 for fixing the first fixing plate 41 and the second fixing plate 42. The locking member 43 is configured to lock the cover plate 3 and the powder distribution device 2 along the X-axis direction, the Y-axis direction, and the Z-axis direction, so as to avoid a problem of uneven raw material distribution caused by shaking of the magnetic raw material loaded in the mold cavity 101. It can be understood that a plurality of locking members 43 are provided, and the plurality of locking members 43 are disposed nearby the cover plate 3 and the powder distribution device 2 for fixing. The locking member 43 may be, for example, a locking rod used in cooperation with the first fixing plate 41 and the second fixing plate 42, and the locking rod penetrates through the first fixing plate 41 and the second fixing plate 42 and is detachably connected to the first fixing plate 41 and the second fixing plate 42 to achieve locking and unlocking operations.

In an example, FIG. 13 is a structural schematic diagram of a first preset shape. Referring to FIG. 13, the first preset shape includes at least one of a bread-type shape, a tile-type shape, and a tile-type shape, where FIG. 13(a) is a structural schematic diagram of the bread-type shape, FIG. 13(b) is a structural schematic diagram of the tile-type shape, and FIG. 13(c) is a structural schematic diagram of the tile-like shape.

In the mold of the present disclosure, all the components are detachable structures, which facilitates the arrangement of the mold cavity 101 before molding and the demolding of the workblank after molding, and improves the production efficiency.

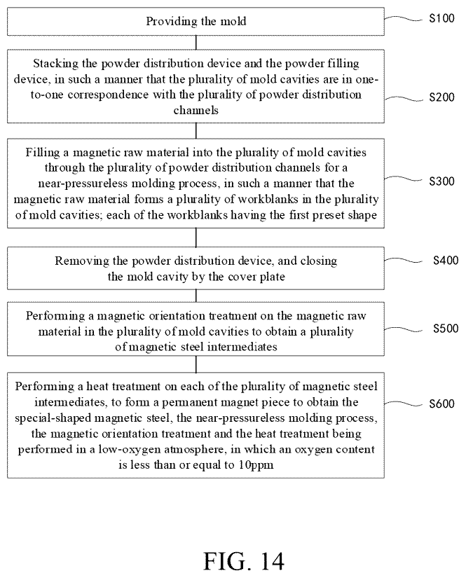

FIG. 14 is a flowchart of a method for forming a special-shaped magnetic steel according to an embodiment of the present disclosure. Referring to FIG. 14, the special-shaped magnetic steel is formed by using the mold described above, and the method includes the following steps: stacking the powder distribution device 2 and the powder filling device 1, in such a manner that the plurality of mold cavities 101 are in one-to-one correspondence with the plurality of powder distribution channels 221; filling the magnetic raw material into the plurality of mold cavities 101 through the plurality of powder distribution channels 221, in such a manner that the magnetic raw material forms the workblank having a first preset shape in the mold in a near-pressureless molding process; removing the powder distribution device 2, and closing the mold cavity 101 by the cover plate 3; performing a magnetic orientation treatment on the workblank to obtain a magnetic steel intermediate; performing a heat treatment on the magnetic steel intermediate, in such manner that the magnetic steel intermediate forms a permanent magnet piece to obtain the special-shaped magnetic steel.

The near-pressureless molding process, the magnetic orientation treatment and the heat treatment are all performed in a low-oxygen atmosphere, in which the oxygen content is less than or equal to 10 ppm.

In the above-described embodiments of the present disclosure, the workblank having controllable size and morphology is obtained by adopting the mold auxiliary and near-pressureless forming process, the shape of the mold can be designed according to a size of the finished product of the special-shaped magnetic steel, without needing to cut the workblank, therefore, the manufacturing efficiency is greatly improved. Meanwhile, the near-pressureless molding process is performed at a normal pressure or a small pressure, so that the raw material has a small waste, the formed workblank has a low inner stress, the buckling deformation thereof is small, and it is beneficial to improving the mechanical stability of the special-shaped magnetic steel that is formed. Further, the magnetic orientation treatment is performed on the workblank, so that the workblank obtains magnetism. Finally, the special-shaped magnetic steel is obtained through the heat treatment. According to the embodiments of the present disclosure, firstly the molding process is performed, then the magnetic orientation treatment is performed, that is, the molding process and the magnetic orientation treatment are two independent operations, so that the formed workblank can be subjected to reinforced molding in the orientation treatment process, the molding density and the orientation degree of the magnetic steel can be improved, thereby obtaining the special-shaped magnetic steel product with high remanence and high coercivity.

The method for forming the magnetic steel will be described below in connection with the drawings in the present disclosure, and it is apparent that the embodiments described herein are only some of the embodiments of the present disclosure, not all of them. All other embodiments obtained by those skilled in the art based on the embodiments of the present disclosure without paying creative efforts shall fall into the protection scope of the present disclosure.

At S100, the mold is provided.

At S200, the powder distribution device 2 and the powder filling device 1 are stacked, in such a manner that the plurality of mold cavities 101 are in one-to-one correspondence with the plurality of powder distribution channels 221.

In an example, before stacking the powder distribution device 2 and the powder filling device 1, the method further includes: assembling the powder distribution device 2 and the powder filling device 1, for example, stacking the reinforcing plate 23, the support plate 21 and the powder distribution plate 22 in sequence, in such a manner that the second hollow area 23a, the first hollow area 21a and the powder distribution channel 221 are aligned, and connecting the reinforcing plate 23, the supporting plate 21 and the powder distribution plate 22 together by a bolt. The bottom plate 12 and the powder filling plate 11 are stacked and connected to each other by a bolt.

At S300, the magnetic raw material enters the mold cavity 101 through the powder distribution channel 221 for near-pressureless molding, is such a manner that the magnetic raw material forms the workblank having a first preset shape in the mold cavity 101.

In an example, the magnetic raw material refers to mixed fine powder obtained after the magnetic raw material is sequentially subjected to a quick-setting process, a hydrogen crushing process and an airflow grinding process; and the magnetic raw material is obtained by composing, mixing, smelting, casting a raw material piece of a rare earth element.

In an example, magnetic raw material includes metal powder or alloy powder formed by at least one of iron, aluminum, nickel, cobalt, copper, for example, the magnetic raw material includes neodymium iron boron alloy powder, ferrite powder, aluminum nickel cobalt powder and iron chromium cobalt powder, or the like, or other permanent magnetic powder. The magnetic raw material is not limited in the present disclosure, and it may be purchased through commercial channels, or may be prepared by the technical personnel in this field.

In an example, since the workblank of the present disclosure is not subjected to pressure treatment or isostatic pressing treatment before magnetic orientation, the stress distribution inside the workblank is uniform. The present disclosure may select a raw material with a smaller size for preparation, which is beneficial to obtaining the remanence of the magnetic steel. The median particle size of the magnetic raw material may be within a range from 1 μm to 4 μm, for example, 1 μm, 1.5 μm, 2 μm, 2.5 μm, 3 μm, 3.5 μm or 4 μm, or the like, or any other value within the above-mentioned range, which will not be limited herein. Within the above-mentioned range, the magnetic raw material of the present disclosure has a small particle size, which is beneficial to improving the stability of the magnetic conductivity frequency of the magnetic raw material in the subsequent magnetic orientation treatment, and improving the magnetic conductivity stability of the magnetic steel.

In an example, the density of the magnetic raw material filled in the mold cavity 101 may be within a range from 2.7 g/cm³ to 4.0 g/cm³, for example, 2.7 g/cm³, 3 g/cm³, 3.3 g/cm³, 3.5 g/cm³, 3.8 g/cm³ or 4.0 g/cm³, or the like, or any other value within the above-mentioned range, which will not be limited herein. Within the above-mentioned range, the magnetic raw material in the mold cavity 101 of the present disclosure has a relatively low density, and a product with a relatively high orientation degree can be obtained by a subsequent magnetic orientation treatment.

In an example, a density distribution of the magnetic raw material powder filled in each mold cavity 101 is less than or equal to 3%, for example, 0.5%, 1%, 1.5%, 2%, 2.5%, or 3%, or any other value within the above-mentioned range, which will not be limited herein. The density distribution refers to a difference between the density of the powder in each mold cavity 101 and an average density of the powder in all the mold cavities 101. Within the above-mentioned range, it indicates that the powder distribution in the plurality of mold cavities 101 of the present disclosure is relatively uniform, which is beneficial to improving the quality balance of the magnetic steel in batch production.

In an example, when filling the magnetic raw material into the mold cavity 101 through the plurality of powder distribution channels 221, the uniformity of the distribution of the magnetic raw material in each powder distribution channel 221 should be ensured, that is, a fluctuation difference of the amounts of the magnetic raw material in the plurality of powder distribution channels 221 is less than 1%.

In an example, the magnetic raw material enters the mold cavity 101 in a near-pressureless molding manner, including but not limited to gas impact beating, vibration, and a manner of compacting surface powder with a punch. In the process of forming the workblank, it is performed under a normal pressure a or small pressure, so that the raw material has a small waste, the formed workblank has a low inner stress, the buckling deformation thereof is small, and it is beneficial to improving the mechanical stability of the magnetic steel.

In an example, the mold and the method for forming magnetic steel according to the present disclosure are mainly used for forming special-shaped magnetic steel. The first preset shape includes but is not limited to at least one of a bread-type shape, a tile-type shape, or a tile-like shape. Compared with magnetic steel having a conventional rectangular shape, the magnetic steel having a bread-type shape, a tile-type shape or a tile-like shape have advantages of uniform air gap density distribution, small cogging torque, small noise and easiness in fixing, and thus can be widely applied to motors for power steering systems, and then can be further applied to automobiles including motors for power steering systems.

At S400, the powder distribution device 2 is removed, and the mold cavity 101 is closed by the cover plate 3.

In an example, the powder distribution device 2 is removed, and then the cover plate 3 is placed on the powder filling device 1, in such a manner that the cover plate 3 closes the mold cavity 101, and the cover plate 3 and the mold cavity 101 jointly form a closed mold cavity.

In an example, the cover plate 3 and the powder filling device 1 can be fixed together by a bolt, which facilitates a subsequent magnetic orientation treatment.

At S500, a magnetic orientation treatment is performed on the workblank, to obtain a magnetic steel intermediate.

At this step, the orientation direction of the workblank needs to be predetermined, and after the orientation direction is determined, the powder filling device 1 loaded with the workblank and the cover plate 3 are placed in a coil through which a direct current passes. The coil can form a magnetic field, the workblank is applied with the magnetic field along the orientation direction, and the magnetic field intensity is gradually increased to make the magnetic field of the workblank reach a saturated state, that is, to obtain magnetism. In an example, the orientation direction of the workblank of the present disclosure includes, but is not limited to, a radial orientation direction, a radiation orientation direction, or the like, or other orientation direction, which will not be limited herein in the present disclosure.

In an example, the magnetic induction intensity of the magnetic orientation treatment may be within a range from 2T to 7T, for example, may be 2T, 3T, 4T, 5T, 6T or 7T, or any other value within the above-mentioned range, which will not be limited herein in the present disclosure. Due to the fact that the workblank is not subjected to a pressure treatment or an isostatic pressing treatment before the magnetic orientation, the inner stress distribution in the workblank is uniform, so that the workblank may be subjected to an orientation treatment in an ultrahigh magnetic field, and the orientation degree and strength of the magnetic steel are ensured.

In an example, the magnetic orientation treatment includes but is not limited to pulse orientation. The pulse orientation is discharged through a high-voltage small-capacity capacitor, so that the coil generates a short ultra-strong magnetic field, magnetic steel with high coercivity may be obtained through a pulse orientation process, the pulse orientation has no special requirement on power supply configuration at a work site, and the use thereof is convenient and flexible.

In an example, during the magnetic orientation treatment on the workblank, the fixing device 4 is used in advance to fix the powder filling device 1 and the cover plate 3, so as to prevent the powder filling device 1 from shaking during the orientation process to affect the orientation process effect.

At S600, a heat treatment is performed on the magnetic steel intermediate, in such a manner that the magnetic steel intermediate forms a permanent magnet piece to obtain magnetic steel.

In an example, before the heat treatment is performed on the magnetic steel intermediate, the cover plate 3 is removed and the powder filling device 1 is reversely buckled on the burning plate, and the fixing between the bottom plate 12 and the powder filling plate 11 is released, so that the magnetic steel intermediate is placed on the burning plate.

In an example, before the heat treatment is performed on the magnetic steel intermediate, the cover plate 3 is removed and the fixing between the bottom plate 12 and the powder filling plate 11 is released, so that the magnetic steel intermediate is placed on the bottom plate 12. In this way, the bottom plate 12 may be used not only to close the mold cavity 101, but also to serve as a bearing plate for the heat treatment and sintering.

In an example, the temperature of the heat treatment may be within a range from 1000° C. to 1100° C., for example, 1000° C., 1010° C., 1020° C., 1030° C., 1040° C., 1050° C., 1060° C., 1070° C., 1080° C., 1090° C. or 1100° C., or the like. Within the above-mentioned range, it can ensure that the magnetic steel intermediate is completely sintered to obtain a magnetic steel product with high hardness and excellent magnetism.

In an example, the direction of the heat treatment may be within a range from 2 h to 6 h, for example, 2 h, 3 h, 4 h, 5 h or 6 h, or the like, or any other value within the above-mentioned range, which will not be limited herein.

In an example, the near-pressureless molding process, the magnetic orientation treatment, and the heat treatment are performed in a low-oxygen atmosphere. The oxygen content in the low-oxygen atmosphere is less than or equal to 10 ppm, for example, 1 ppm, 3 ppm, 5 ppm, 7 ppm, 9 ppm or 10 ppm, or the like. Within the above-mentioned range, a risk of oxidation of the magnetic raw material can be reduced, and it facilitates improving the crystal orientation degree of the workblank in the orientation process; meanwhile, it can ensure the uniform stress distribution of the workblank, reduce the orientation difficulty, and avoid introducing impurities in the heat treatment process to reduce the purity of the magnetic steel, thereby improving the quality of the magnetic steel.

The method provided the present disclosure is different from a conventional molding treatment, and the pressing and orientation treatment of the magnetic raw material are performed separately. Pressing is performed through a near-pressureless process, without needing to cut or press, and the workblank has uniform stress distribution, so that a risk of cracking and deformation of the workblank in the subsequent treatment process is avoided. Meanwhile, the near-pressureless molding process is simple, the raw material utilization rate is high, and the product utilization degree can be improved while the process flow is shortened. The workblank before the orientation is protected by the mold, and then the workblank is oriented in the ultra-strong magnetic field within a range from 3T to 7T, thereby ensuring the orientation degree and the magnetic field intensity of the magnetic steel.

The embodiments of the disclosure further provide magnetic steel, which is formed by the mold and the method described above, and has the characteristics of uniform stress distribution, a high density, a good orientation degree, high remanence and high coercivity.

In an example, the density of the magnetic steel is within a range from 2.0 g/cm³ to 4.2 g/cm³, for example, 2.0 g/cm³, 2.5 g/cm³, 2.8 g/cm³, 3.2 g/cm³, 3.5 g/cm³, 3.8 g/cm³, 4.2 g/cm³, or the like, or any other value within the above-mentioned range, which will not be limited herein.

In an example, an orientation degree of the magnetic steel is greater than or equal to 97%, for example, 97%, 97.5%, 98%, 98.5% or 99%, or the like, or any other value within the above-mentioned range, which will not be limited herein.

The embodiments of the present disclosure further provide a motor, including the magnetic steel described above. In this way, the magnetic steel provided by the present disclosure has advantages of high remanence, high coercivity, a uniform air gap magnetic density, a small cogging torque, small noise, and easy fixation and installation, and can be widely applied to various driving motors of electronic devices such as automobiles.

The above-described embodiments are merely preferred embodiments of the present disclosure and are not intended to limit the present disclosure. Various changes and modifications can be made to the present disclosure by those skilled in the art. Any modifications, equivalent substitutions and improvements made within the principle of the present disclosure shall fall into the protection scope of the present disclosure.

Although the present disclosure is disclosed above with the preferred embodiments, but the present disclosure is not limited thereto. Any of those skilled in the art can make several possible changes and modifications without departing from a concept of the present disclosure, thus the protection scope of the present disclosure shall be defined by the claims of the present disclosure.

What is claimed is:

1. A mold for forming special-shaped magnetic steel, wherein the mold comprises:
a powder filling device, wherein the powder filling device comprises a plurality of mold cavities, each of the plurality of mold cavities comprises an opening at one end, and each of the plurality of mold cavities has a first preset shape;
a powder distribution device, wherein the powder distribution device comprises a powder distribution area, and a plurality of powder distribution channels are provided in the powder distribution area, the plurality of powder distribution channels penetrate through the powder distribution device along a first direction, each of the plurality of powder distribution channels has a second preset shape, positions of the plurality of powder distribution channels correspond to positions of the plurality of mold cavities, the first preset shape is the same as the second preset shape, and the first direction is parallel to a height direction of the powder distribution device; and
a cover plate configured to close the plurality of mold cavities.

2. The mold as described in claim 1, wherein the powder filling device comprises a bottom plate and a powder filling plate arranged on the bottom plate, the powder filling plate comprises a plurality of powder filling channels penetrating through the powder filling plate along the first direction, positions of the plurality of powder filling channels correspond to the positions of the plurality of powder distribution channel, and the plurality of powder filling channels and the bottom plate jointly enclose to define the plurality of mold cavities.

3. The mold as described in claim 1, wherein the powder distribution device comprises a support plate and a powder distribution plate arranged at a side of the support plate, the plurality of powder distribution channels are arranged at the powder distribution plate, the support plate comprises a first hollow area, and the first hollow area corresponds to the plurality of powder distribution channels.

4. The mold as described in claim 3, wherein a length of the support plate along a second direction is greater than a length of the powder distribution plate along the second direction, and the second direction is perpendicular to the first direction.

5. The mold as described in claim 3,
wherein the powder distribution device further comprises a reinforcing plate arranged at a side of the support plate, the reinforcing plate and the powder distribution plate are respectively arranged at two sides of the support plate, the reinforcing plate is arranged at a side of the support plate facing away from the powder filling device, the reinforcing plate comprises a second hollow area, and the second hollow area corresponds to the first hollow area; and
wherein a length of the reinforcing plate along the first direction is greater than a length of the support plate along the first direction, and the length of the reinforcing plate along the first direction is greater than a length of the powder distribution plate along the first direction.

6. The mold as described in claim 1, further comprising a fixing device, wherein the fixing device is configured to lock the cover plate and the powder distribution device along the first direction and along a second direction perpendicular to the first direction.

7. The mold as described in claim 1, wherein the powder filling device is detachably connected to the powder distribution device, and/or the powder distribution device is detachably connected to the cover plate.

8. The mold as described in claim 1, wherein the first preset shape comprises at least one of a bread-type shape, a tile-type shape and a tile-like shape.

9. A method for forming special-shaped magnetic steel, wherein the special-shaped magnetic steel is formed by a mold,
wherein the mold comprises:
a powder filling device, wherein the powder filling device comprises a plurality of mold cavities, each of the plurality of mold cavities comprises an opening at one end, and each of the plurality of mold cavities has a first preset shape;
a powder distribution device, wherein the powder distribution device comprises a powder distribution area, and a plurality of powder distribution channels are provided in the powder distribution area, the plurality of powder distribution channels penetrate through the powder distribution device along a first direction, each of the plurality of powder distribution channels has a second preset shape, positions of the plurality of powder distribution channels correspond to positions of the plurality of mold cavities, the first preset shape is the same as the second preset shape, and the first direction is parallel to a height direction of the powder distribution device; and
a cover plate configured to close the plurality of mold cavities, and
wherein the method comprises:
providing the mold;
stacking the powder distribution device and the powder filling device, in such a manner that the plurality of mold cavities are in one-to-one correspondence with the plurality of powder distribution channels;
filling a magnetic raw material into the plurality of mold cavities through the plurality of powder distribution channels for a near-pressureless molding process, in such a manner that the magnetic raw material forms a plurality of workblanks in the plurality of mold cavities; each of the workblanks having the first preset shape;
removing the powder distribution device, and closing the mold cavity by the cover plate;
performing a magnetic orientation treatment on the magnetic raw material in the plurality of mold cavities to obtain a plurality of magnetic steel intermediates; and
performing a heat treatment on each of the plurality of magnetic steel intermediates, to form a permanent magnet piece to obtain the special-shaped magnetic steel,
wherein the near-pressureless molding process, the magnetic orientation treatment and the heat treatment are performed in a low-oxygen atmosphere, in which an oxygen content is less than or equal to 10 ppm.

10. The method as described in claim 9, wherein before performing the magnetic orientation treatment on the magnetic raw material in the plurality of mold cavities, the method further comprises: locking the cover plate and the powder filling device in the first direction and in the second direction by using the fixing device.

11. The method as described in claim 9,
wherein the near-pressureless molding process comprises at least one of a gas impact treatment, a vibration treatment or a permanent magnet raw material surface compaction treatment;
the magnetic raw material has a median particle size ranging from 1 μm to 4 μm;
the magnetic raw material that enters the plurality of mold cavities through the plurality of powder distribution channels has a density ranging from 2.7 g/cm³ to 4.0 g/cm³, and a density distribution of the magnetic raw material in the plurality of mold cavities of the powder filling device is less than or equal to 3%;
an orientation degree of the workblank is greater than or equal to 97%; and
magnetic induction intensity of the magnetic orientation treatment ranges from 2T to 7T, and the magnetic orientation treatment includes a pulse orientation treatment.
